(19) United States
(12) Patent Application Publication
(10) Pub. No.: US 2006/0068169 A1
(43) Pub. Date: Mar. 30, 2006

(54) Thermoplastic resin foamed sheet

(75) Inventors: Satoshi Hanada, Ichihara-shi (JP); Yoshinori Ohmura, Osaka (JP)

Correspondence Address: FITCH, EVEN, TABIN & FLANNERY, P. O. BOX 65973, WASHINGTON, DC, 20035, US

(73) Assignees: Sumitomo Chemical Company, Limited, Tokyo (JP); Sumika Plastech Co., Ltd., Tokyo (JP)

(21) Appl. No.: 11/225,085

(22) Filed: Sep. 14, 2005

(30) Foreign Application Priority Data
Sep. 17, 2004 (JP) 2004-271234

(51) Int. Cl. B32B 3/12

(52) U.S. Cl. 428/158; 428/166

(57) ABSTRACT

Disclosed is a thermoplastic resin foamed sheet wherein pillar-shaped resin portions observed in a cross section in the thickness direction of the sheet satisfy requirement (1): the number density of pillar-shaped resin portions intersecting the thickness centerline of the foamed sheet is from 1 to 20 pillars/mm-centerline and requirement(2): the average thickness of pillar-shaped resin portions intersecting the thickness centerline of the foamed sheet is from 10 to 500 μm.

### BACKGROUND OF THE INVENTION

1. Field of the Invention

This invention relates to thermoplastic resin foamed sheets.

2. Description of the Related Art

Thermoplastic resin foamed sheets are superior in lightweight property, recyclability, heat insulation property, etc. and, therefore, are used for various applications such as automotive component materials, building or construction materials and packaging materials. In particular, cushioning property is required when foamed sheets are used as automotive interior components or building or construction materials. Japanese Patent Application Publication No. 08-231745 discloses a propylene-based resin foamed sheet in which cells have been compressed in the thickness direction, namely, a foamed sheet in which the cell size in the thickness direction of the foamed sheet is smaller than the cell sizes in the width and longitudinal directions of the foamed sheet.

However, even such a foamed sheet having cells compressed in the thickness direction is unsatisfactory in cushioning property for use in applications such as automotive interior component applications and the like.

### SUMMARY OF THE INVENTION

The present invention provides a thermoplastic resin foamed sheet superior in cushioning property.

The present invention is directed to a thermoplastic resin foamed sheet wherein pillar-shaped resin portions observed in a cross section in the thickness direction of the sheet satisfy requirements (1) and (2) defined below:

(1) the number density of pillar-shaped resin portions intersecting the thickness centerline of the foamed sheet is from 1 to 20 pillars/mm-centerline;

(2) the average thickness of pillar-shaped resin portions intersecting the thickness centerline of the foamed sheet is from 10 to 500 μm.

### BRIEF DESCRIPTION OF THE DRAWINGS

In the drawings,

FIG. 1 is a schematic diagram showing a cross section in the thickness direction of the thermoplastic resin foamed sheet of the present invention,

FIG. 2 is a schematic diagram showing one embodiment of the production of the thermoplastic resin foamed sheet of the present invention,

FIG. 3 is a schematic diagram showing another embodiment of the production of the thermoplastic resin foamed sheet of the present invention,

FIG. 4 is a schematic diagram showing another embodiment of the production of the thermoplastic resin foamed sheet of the present invention,

FIG. 5 is a schematic diagram showing another embodiment of the production of the thermoplastic resin foamed sheet of the present invention,

FIG. 6 is a diagram which shows one example of the apparatus for producing an initial thermoplastic resin foamed sheet,

FIG. 7 is a diagram which shows one example of the cross-sectional shape of the circular die for use in the production of an initial thermoplastic resin foamed sheet, and

FIG. 8 shows the sound absorptivities measured using the thermoplastic resin foamed sheet produced in Example 1.

The signs in the drawings have meanings shown below: 1: cross section in the thickness direction of a thermoplastic resin foamed sheet of the present invention; 2: pillar-shaped resin portion; 3: cells having a ratio of its maximum inner length in the MD (or TD) to that in the thickness direction of 1 or more; 4: thickness centerline of a foamed sheet; 5: initial thermoplastic resin foamed sheet; 6: clip; 7: infrared heater; 8, 9, 12, 13: mold; 10: air tightness holding member (cushioning material); 11: air tightness holding section; 14: sheet fixing member; 15: apparatus for producing an initial thermoplastic resin foamed sheet; 16: 50 mmφ twin screw extruder; 17: 32 mmφ single screw extruder; 18: circular die; 19: pump for supplying carbon dioxide gas; 20: mandrel; 21: head of a 50 mmφ twin screw extruder; 22: head of a 32 mmφ single screw extruder; 23a, 23b, 24a, 24b, 24c, 24d, 25a, 25b: passageway; 26: outlet of a circular die.

### DESCRIPTION OF THE PREFERRED EMBODIMENTS

The thermoplastic resin foamed sheet of the present invention is characterized in that in a cross section of the foamed sheet in the thickness direction of the foamed sheet, the number density of pillar-shaped resin portions intersecting the thickness centerline of the foamed sheet is from 1 to 20 pillars/mm-centerline. The number density of pillar-shaped resin portions is defined as follows.

A thermoplastic resin foamed sheet is cut across its thickness along its MD direction (the extrusion direction in the production of the foamed sheet) and a cross sectional photograph is taken such that the length of 5 mm or more and the entire thickness of the foamed sheet can be observed and also the cross sectional structure can be observed. In this cross sectional photograph, a thickness centerline of the foamed sheet is drawn. The thickness centerline of the foamed sheets used herein is defined as a line connecting centers in the thickness of the foamed sheet. The number of all pillar-shaped resin portions intersecting the thickness centerline of the foamed sheet observed in the cross sectional photograph is counted. Based on the result, the number of pillar-shaped resin portions per unit length of the thickness centerline of the foamed sheet is calculated. This measurement is carried out for three or more positions 5 cm or more away from each other. On the other hand, the thermoplastic resin foamed sheet the same as that used above is cut across its thickness along its TD direction (the width direction of the extrusion perpendicular to the MD direction of the foamed sheet) and the measurement the same as that described above is carried out for three or more positions 5 cm or more away from each other. An average value of the so-obtained six or more data of the number of pillar-shaped resin portions per unit length of the thickness centerline of the foamed sheet is defined as the number density of the pillar-shaped resin portions of the thermoplastic resin foamed sheet.

The thermoplastic resin foamed sheet of the present invention is also characterized in that the average thickness of pillar-shaped resin portions intersecting the thickness centerline of the foamed sheet is from 10 to 500 μm. In a cross sectional photograph of the foamed sheet taken in the same manner as that for taking a photograph for the determination of the number density of pillar-shaped resin portions, the thicknesses of all pillar-shaped resin portions intersecting the thickness centerline of the foamed sheet are measured. The measurement is conducted at three or more cross sections along the MD direction and three or more cross sections along the TD direction. All the measurements of the thickness of pillar-shaped resin portions are averaged and the resulting average value is defined as the average thickness of pillar-shaped resin portions of the thermoplastic resin foamed sheet.

Thermoplastic resin foamed sheets of the present invention, whose pillar-shaped resin portions observed in a cross section in the thickness direction are characterized in that the number density of pillar-shaped resin portions intersecting the thickness centerline of the foamed sheet is from 1 to 20 pillars/mm-centerline and the average thickness of pillar-shaped resin portions intersecting the thickness centerline of the foamed sheet is from 10 to 500 μm, are superior in cushioning property.

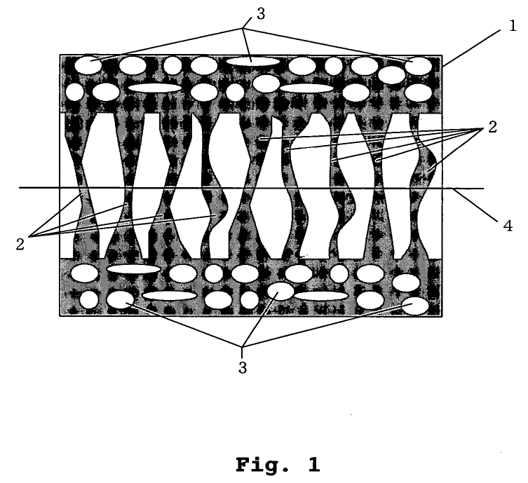

The thermoplastic resin foamed sheet of the present invention is desirably structured such that spherical or spheroidal cells are present in the vicinity of the surface of the foamed sheet and the central portion of the foamed sheet is supported by pillar-shaped resin portions as shown in FIG. 1. It is desirable that the average of maximum inner lengths in the foamed sheet's thickness direction of all cell found in a cross section of the foamed sheet taken in the thickness direction along the MD, each cell having a ratio of its maximum inner length in the MD to that in the thickness direction of 1 or more, and all cells found in a cross section of the foamed sheet taken in the thickness direction along the TD, each cell having a ratio of its maximum inner length in the TD to that in the thickness direction of 1 or more, be within the range of from 10 to 500 μm. Such thermoplastic resin foamed sheets of the present invention are superior in cushioning property and flexural rigidity.

It is more desirable for the thermoplastic resin foamed sheet of the present invention to have an expansion ratio of from 5 to 40, a thickness of from 2 to 50 mm, and a closed cell percentage of from 0 to 30% from the viewpoints of cushioning property and flexural rigidity.

Examples of the resin for forming the thermoplastic resin foamed sheet include olefin-based resin such as homopolymers of olefins having 6 or less carbon atoms e.g. ethylene, propylene, butene, pentene and hexene, olefin copolymers produced by copolymerizing two or more kinds of monomer selected from olefins having form 2 to 10 carbon atoms, ethylene-vinyl ester copolymers, ethylene-(meth)acrylic acid copolymers, ethylene-(meth)acrylic ester copolymers, ester resin, amide resin, styrenic resin, acrylic resin, acrylonitrile-based resin and ionomer resin. These resins may be used either solely or in the form of blend of two or more resins. Among these resins, olefin-based resins are preferably used from the viewpoints of moldability, oil resistance and cost. Propylene-based resins are particularly preferably used from the viewpoint of rigidity and heat resistance of resulting foamed sheets.

Examples of the propylene-based resins include propylene homopolymers and propylene-based copolymers including at least 50 mol % of propylene units. The copolymers may be block copolymers, random copolymers or graft copolymers. Examples of the propylene-based copolymers to be suitably employed include copolymers of propylene with ethylene or an α-olefin having 4 to 10 carbon atoms. Examples of the α-olefin having 4 to 10 carbon atoms include 1-butene, 4-methylpentene-1,1-hexene and 1-octene. The content of the monomer units except propylene units in the propylene-based copolymer is preferably up to 15 mol % for ethylene and up to 30 mol % for α-olefins having 4 to 10 carbon atoms. A single kind of propylene-based resin may be used. Alternatively, two or more kinds of propylene-based resin may also be used in combination.

When a long-chain-branching propylene-based resin or a propylene-based resin having a weight average molecular weight of 1×10⁵ or more is used in an amount of 50% by weight or more of the thermoplastic resin forming the foamed layer, it is possible to produce a propylene-based resin foamed sheet containing finer cells.

By the “long-chain-branching propylene-based resin” used herein is meant a propylene-based resin whose branching index [A] satisfies 0.20≦[A]≦0.98. One example of the long-chain-branching propylene-based resins having a branching index [A] satisfying 0.20≦[A]≦0.98 is Propylene PF-814 manufactured by Basell Co.

The branching index quantifies the degree of long chain branching in a polymer and is defined by the following formula.
Branching index [A]=[η]_{Br}/[η]_{Lin}
In the formula, [η]_{Br} is the intrinsic viscosity of the long-chain-branching propylene-based resin. [η]_{Lin} is the intrinsic viscosity of a linear propylene-based resin made up of monomer units the same as those of the long-chain-branching propylene-based resin and having a weight average molecular weight the same as that of the long-chain-branching propylene-based resin.

The intrinsic viscosity, which is also called a limiting viscosity number, is a measure of the capacity of a polymer to enhance the viscosity of its solution. The intrinsic viscosity depends especially on the molecular weight and on the degree of branching of the polymer molecule. Therefore, the ratio of the intrinsic viscosity of the long-chain-branching polymer to the intrinsic viscosity of a linear polymer having a molecular weight equal to that of the long-chain-branching polymer can be used as a measure of the degree of branching of the long-chain-branching polymer. The intrinsic viscosity of a propylene-based resin can be determined by a conventionally known method such as that described by Elliott et al., J. Appl. Polym. Sci., 14, 2947-2963 (1970). For example, the intrinsic viscosity can be measured at 135° C. by dissolving the propylene-based resin in tetralin or orthodichlorobenzene.

The weight average molecular weight (Mw) of a propylene-based resin may be determined by various methods commonly used. Particularly preferably employed is the method reported by M. L. McConnel et al. in American Laboratory, May, 63-75 (1978), namely, the low-angle laser light-scattering intensity measuring method.

One example of the method for producing a high-molecular-weight propylene-based resin having a weight average molecular weight of 1×10⁵ or more by polymerization is a method in which a high molecular weight component is produced first and then a low molecular weight component is produced as described in Japanese Patent Application Publication No. 11-228629.

Among the long-chain-branching propylene-based resin and the high-molecular-weight propylene-based resin, preferred is a propylene-based resin having a uniaxial melt elongation viscosity ratio η₅/η_{0.1} of 5 or more, more preferably 10 or more, measured under the conditions given below at about a temperature 30° C. higher than the melting point of the resin. The uniaxial melt elongation viscosity ratio is a value measured at an elongation strain rate of 1 sec⁻¹ using a uniaxial elongation viscosity analyzer (for example, a uniaxial elongation viscosity analyzer manufactured by Rheometrix), wherein η_{0.1} denotes a uniaxial melt elongation viscosity detected 0.1 second after the start of strain and η₅ denotes a uniaxial melt elongation viscosity detected 5 seconds after the start of strain.

As the foaming agent for use in the preparation of the foamed sheet, either of the chemical foaming agent or the physical foaming agent may be used. Moreover, both types of foaming agents may be used together. Examples of the chemical foaming agent include known thermally decomposable compounds such as thermally decomposable foaming agents which form nitrogen gas through their decomposition (e.g., azodicarbonamide, azobisisobutyronitrile, dinitrosopentamethylenetetramine, p-toluenesulfonyl hydrazide, p,p′-oxy-bis(benzenesulphonyl hydrazide); and thermally decomposable inorganic foaming agents (e.g., sodium hydrogencarbonate, ammonium carbonate and ammonium hydrogencarbonate). Specific examples of the physical foaming agent include propane, butane, water and carbon dioxide gas. Among the foaming agents provided above as examples, water and carbon dioxide gas are suitably employed because foamed sheets produce less deformation caused by secondary foaming during heating in vacuum forming and also because those agents are substances inert at high temperatures and inert to fire. The amount of the foaming agent used is appropriately determined on the basis of the kinds of the foaming agent and resin used so that a desired expansion ratio is achieved. However, 0.5 to 20 parts by weight of foaming agent is normally used for 100 parts by weight of thermoplastic resin.

The thermoplastic resin foamed sheet of the present invention may include additives. Examples of the additives include filler, antioxidants, light stabilizers, ultraviolet absorbers, plasticizers, antistatic agents, colorants, release agents, fluidizing agents and lubricants. Specific examples of the filler include inorganic fibers such as glass fiber and carbon fiber and inorganic particles such as talc, clay, silica, titanium oxide, calcium carbonate and magnesium sulfate.

Thermoplastic resin foamed sheets of the present invention may be produced by the method described below.

At first, a thermoplastic resin foamed sheet, which is to be used an initial sheet, is produced by a conventional method such as extrusion foaming using a flat die (T-die) or a circular die. By vacuum forming the resulting initial thermoplastic resin foamed sheet, a thermoplastic resin foamed sheet of the present invention can be obtained. The vacuum forming may be carried out by a vacuum forming method including the steps provided below using a molding apparatus including a pair of molds each having a molding surface through which vacuum sucking can be conducted:

(1) heating a thermoplastic resin foamed sheet to soften it;

(2) supplying the thermoplastic resin foamed sheet softened in step (1) between the molds;

(3) while holding the softened thermoplastic resin foamed sheet between the molds, closing the molds until a clearance between peripheral portions of the molding surfaces of the molds arrives at a predetermined value not greater than the thickness of the softened thermoplastic resin foamed sheet;

(4) starting vacuum sucking through the molding surfaces of the molds at a point of time during a period from the arrival of the clearance between the peripheral portions of the molding surfaces of the molds at the thickness of the softened thermoplastic resin foamed sheet to the arrival of the clearance at the predetermined value defined in step (3) or under conditions where the clearance between the peripheral portions of the molding surfaces of the molds is the predetermined value defined in step (3);

(5) while continuing the vacuum sucking, shaping the sheet into a shape defined by the molding surfaces of the molds;

(6) a combination of stopping the vacuum sucking, opening the molds and removing the molded article.

The so-produced article is a thermoplastic resin foamed sheet of the present invention.

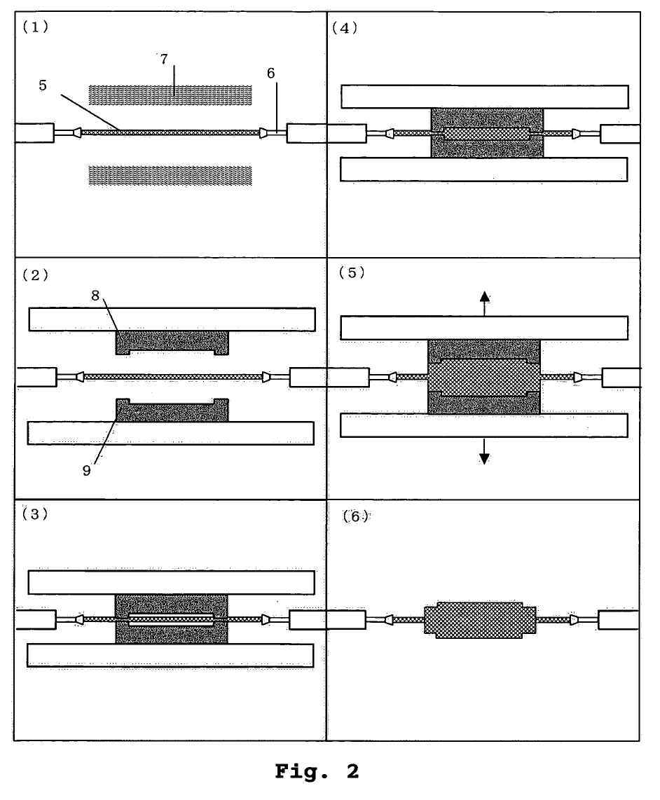

The vacuum forming method is explained in detail below with reference to FIG. 2.

A pair of opposing molds each having a molding surface through which vacuum sucking can be conducted is used. Examples of the paired molds include a pair of one male mold and one female mold, a pair of two female molds, and a pair of two flat molds.

Examples of the mold having a molding surface through which vacuum sucking can be conducted include molds having a molding surface at least part of which is composed of sintered alloy and molds having a molding surface provided, at least in its restricted section, with one or more holes through which air is exhausted. The number, location and diameter of the hole or holes with which the molds are provided are not particularly limited if an initial thermoplastic resin foamed sheet supplied between the molds can be shaped into the shapes of the molding surfaces of the molds.

The molds have no particular limitations on their material, but from the viewpoints of dimensional stability, durability and thermal conductivity, they are typically made of metal. From the viewpoints of cost and weight, the molds are preferably made of aluminum.

The molds are preferably structured so that the temperature thereof can be controlled by a heater or heat medium. For improving the lubricity of a foamed sheet or preventing a foamed sheet from cooling before completion of its molding, the temperatures of the molding surfaces of the molds are preferably adjusted within a range of from 30 to 80° C., more preferably from 50 to 60° C.

It is desirable that at least one mold be a mold having an air tightness holding function. Use of such a mold makes it easy to maintain the degree of vacuum in the cavity when vacuum sucking and makes it possible to produce molded articles with extremely less shrinkage.

One example of the mold having the air tightness holding function is a mold in which the peripheral portion of its molding surface can move toward the opposing mold. Such a mold preferably has a structure such that the movable portion can be collapsed in the mold so that the top face of the movable portion comes in the same level as the peripheral portion of the molding surface at the time of mold closure. Use of such a mold makes it easy to maintain the degree of vacuum in the cavity in a mold opening step which is mentioned later because the mold is structured so that the movable portion protrudes as the mold is opened.

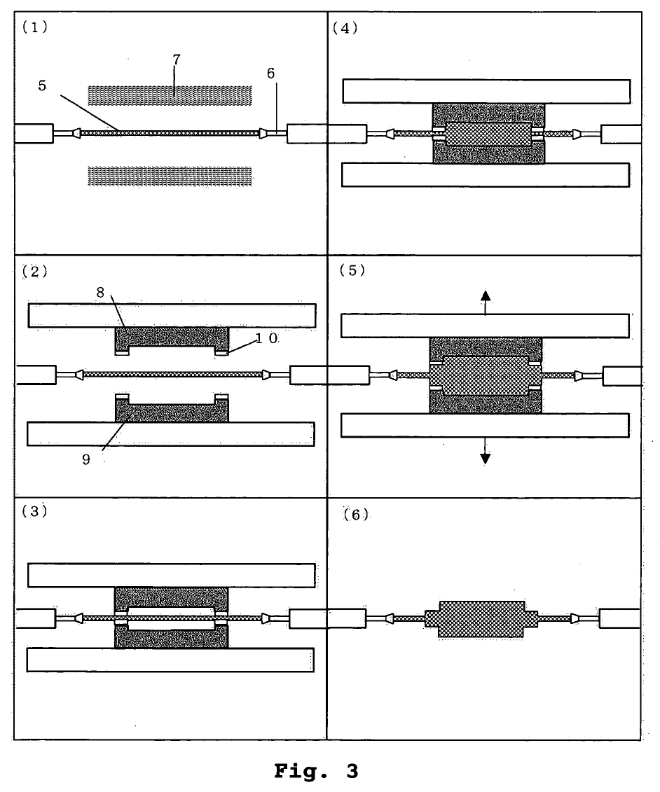

Another example of the mold having the air tightness holding function is a mold having a cushioning material on the peripheral portion of the molding surface as shown in FIG. 3. Foamed sheets normally have fine unevenness on their surfaces. When a mold having a cushioning material is used, it is easy to maintain the degree of vacuum in the cavity when vacuum sucking is carried out because the cushioning material will come into intimate contact with a finely uneven surface of a foamed sheet through mold closure. The cushioning material may be rubber, foam and the like.

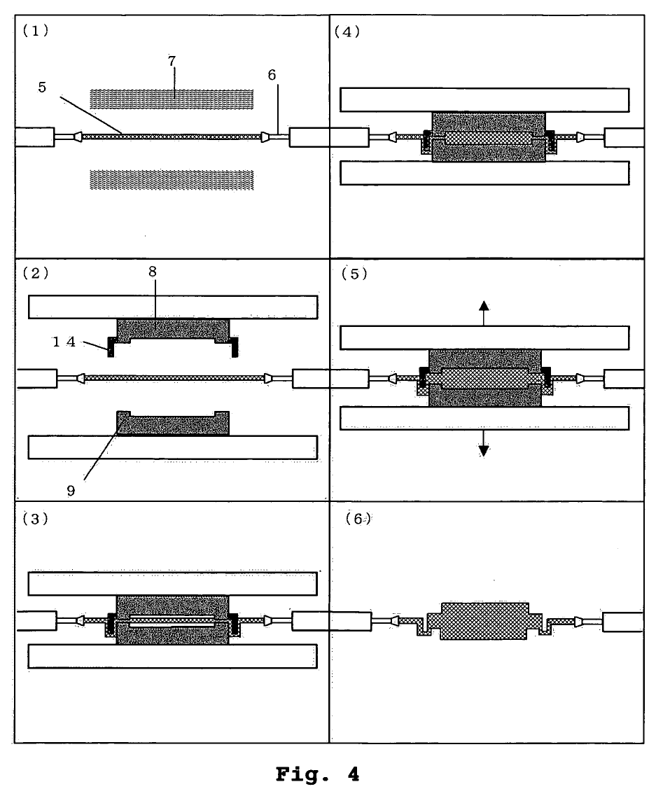

A pair of molds such as those shown in FIG. 4 are also usable wherein one mold is covered with an air tightness holding section provided on the periphery of the other mold when the molds are closed.

Molds may have means for fixing an initial foamed sheet on their molding surfaces and/or peripheral portions of the molding surfaces. Examples of such means include adhesive, pins, hooks, clips and slits. Use of a mold having such fixing means makes it easy to shape an initial foamed sheet into the shape of the molding surface.

Regarding the molding apparatus, it is desirable to use a molding apparatus such that the molding surfaces of both molds will define there between a cavity with a height as high as 0.8 to 2 times the thickness of the foamed sheet softened in step (1) at the completion of mold closure. The height of a cavity referred to herein means the distance between the molding surfaces corresponding to the thickness direction of the foamed sheet supplied between the molds. The cavity is not required to have the same height at all places in the cavity. The cavity may be any one having a shape corresponding to the shape of a desired molded article. If the height of the cavity defined at completion of mold closure is too small, cells in the foamed sheet may be broken. If it is too large, it becomes difficult to shape the foamed sheet by bringing the surfaces of the foamed sheet into contact with the molding surfaces of the molds even if vacuum sucking is carried out. Even if the foamed sheet is brought into contact with the molding surfaces, the foamed sheet becomes susceptible to burst of cells.

FIG. 2-(1) shows step (1) of heating an initial thermoplastic resin foamed sheet and thereby softening it. In step (1), the foamed sheet is usually held in a clamp frame and heated by a heating device such as a far infrared heater, a near infrared heater, a contact type hot plate. A far infrared heater is preferably used because it can heat the foamed sheet efficiently in a short time. It is desirable to heat the foamed sheet so that the foamed sheet comes to have a surface temperature near a melting point of the resin forming the foamed sheet when the resin is a crystalline resin or near a glass transition temperature of the resin when the resin is a non-crystalline resin.

FIG. 2-(2) shows a state where an initial thermoplastic resin foamed sheet softened in step (1) has been supplied between a pair of molds each having a molding surface through which vacuum sucking can be conducted.

FIG. 2-(3) shows a step of closing the molds until a clearance between peripheral portions of the molding surfaces arrives at a predetermined value not greater than the thickness of the softened initial thermoplastic resin foamed sheet while holding the softened initial thermoplastic resin foamed sheet between the molds. Mold closure is carried out so that the opposing molding surfaces of the molds relatively approach to each other. For example, one mold is fixed and the other is moved toward the fixed one. Alternatively, both molds are moved in opposite directions so that the molds approach to each other.

FIG. 2-(4) shows a state where vacuum sucking is carried out through the molding surfaces of the molds. In step (4), the vacuum sucking may be started at any point of time during a period from the arrival of the clearance between the peripheral portions of the molding surfaces at the thickness of the softened thermoplastic resin foamed sheet to the arrival of the clearance at a predetermined value not greater than the foamed sheet or under conditions where the clearance between the peripheral portions of the molding surfaces of the molds is the predetermined value defined in step (3). The molds may be further closed to the predetermined thickness while continuing the vacuum sucking. Alternatively, vacuum sucking may be started simultaneously with the arrival of the clearance at the predetermined thickness or after the arrival of the clearance at the predetermined thickness. When the vacuum sucking is carried out after the foamed sheet comes to have a predetermined thickness, it is usually desirable to start the vacuum sucking before the foamed sheet is cooled and within three seconds from the time when the foamed sheet comes to have the predetermined thickness.

For obtaining a molded article having an internal structure symmetrical with respect to the thickness centerline, it is desirable to start vacuum sucking through one mold and vacuum sucking through the other mold simultaneously. However, it is permissive to make a time difference between the starts of vacuum sucking unless the initial foamed sheet is cooled. When vacuum sucking through one mold is started after the start of vacuum sucking through the other mold, the time difference between the starts of vacuum sucking is preferably within three seconds.

The degree of vacuum sucking is not particularly limited, but it is desirable to suck so that the degree of vacuum in the cavity becomes from −0.05 MPa to −0.1 MPa. The degree of vacuum is a pressure in the cavity with respect to atmospheric pressure. For example, “the degree of vacuum is −0.05 MPa” means that the pressure in the cavity is lower than atmospheric pressure by 0.05 MPa. The higher the degree of vacuum, the more strongly a unprocessed foamed sheet is attracted to a mold. It, therefore, becomes possible to shape the initial foamed sheet into a shape closer to the shape of the cavity. The degree of vacuum of a cavity is a value measured at an opening, provided in the cavity, of a hole through which vacuum sucking is conducted.

FIG. 2-(5) shows a state where the sheet between the molding surfaces has been shaped through mold opening continued until the sheet came to have a thickness of a desired molded article. The opening of the molds are carried out while the vacuum sucking is continued. The speed of mold opening and the degree of vacuum during the mold opening may be adjusted so that the foamed sheet is successfully shaped into the shape of a desired molded article.

The foamed sheet is fully cooled while the molds are held to be opened with the predetermined clearance. Then, the vacuum sucking is stopped and the molds are further opened. Finally, a resulting molded article, namely a thermoplastic resin foamed sheet of the present invention, is removed. FIG. 2-(6) shows a state where the molds (not shown) have been opened for the removal of the molded article.

Thermoplastic resin foamed sheets of the present invention may also be produced by a method described below. The method is a vacuum forming method including the steps provided below using an initial thermoplastic resin foamed sheet such as that previously mentioned and a molding apparatus including a first mold having a molding surface through which vacuum sucking can be conducted and a second mold having a molding surface provided, on at least a peripheral portion of the molding surface of the mold, with sheet fixing member:

(1) heating an initial thermoplastic resin foamed sheet to soften it;

(2) supplying the initial thermoplastic resin foamed sheet softened in step (1) between the first and second molds;

(3) while holding the softened initial thermoplastic resin foamed sheet between the molds, closing the molds until a clearance between peripheral portions of the molding surfaces of the molds becomes a predetermined value not greater than the thickness of the softened thermoplastic resin foamed sheet, thereby bringing the entire area of the molding surface of the second mold into contact with one surface the foamed sheet;

(4) starting vacuum sucking through the molding surface of the first mold after the entire area of the molding surface of the second mold comes into contact with the surface of the foamed sheet in step (3);

(5) while continuing the vacuum sucking, opening the molds until the sheet between the molding surfaces comes to have the thickness of a desired article, thereby shaping the sheet; and

(6) a combination of stopping the vacuum sucking, opening the molds and removing the molded article.

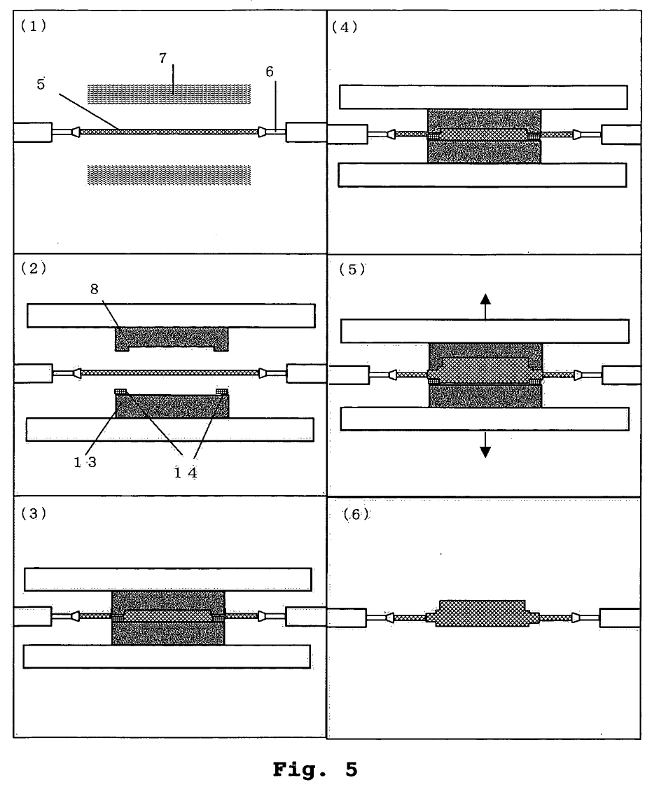

FIG. 5 shows the outline of the vacuum forming method described above. It is possible to produce thermoplastic resin foamed sheets of the present invention by a method which is approximately similar to the previously mentioned method in which a pair of opposing molds each having a molding surface through which vacuum sucking can be conducted and vacuum sucking is carried out through the molds, except for using the molding apparatus including the first mold (12) having a molding surface through which vacuum sucking can be conducted and the second mold (13) having a molding surface provided, on at least a peripheral portion of the molding surface of the mold, with sheet fixing member (14) and vacuum sucking is carried out only through the molding surface of the first mold.

Thermoplastic resin foamed sheet of the present invention is only required to have at least one foamed layer characterized in that pillar-shaped resin portions observed in a cross section in the thickness direction are characterized in that the number density of pillar-shaped resin portions intersecting the thickness centerline of the foamed sheet is from 1 to 20 pillars/mm-centerline and the average thickness of pillar-shaped resin portions intersecting the thickness centerline of the foamed sheet is from 10 to 500 μm. The sheet may be either a unilayer sheet or a multilayer sheet. In the case of a multilayer sheet, it may have a non-foam layer and also may have a foamed layer which does not satisfy the previously mentioned requirements. In the case of a multilayer foamed sheet, it may be produced by co-extrusion or by lamination of a unilayer or multilayer foamed sheet to another material (for example, a skin material) by dry lamination, sandwich lamination, hot roll lamination or hot air lamination.

Examples of the material laminated to the foamed sheet include resin such as thermoplastic resin and thermosetting resin, rubber such as thermoplastic elastomer, natural fiber such as hemp, jute and the like, minerals such as calcium silicate. Examples of the form thereof include film, sheet, non-woven fabric and woven fabric. In addition to the materials mentioned above, synthetic paper made of propylene-based resin or styrene-based resin and thin plate or foil of metal such as aluminum and iron may also be used. The skin material may be composed of either one layer or two or more layers. The skin material may have been provided with decoration such as uneven pattern e.g. grain pattern, print and dyeing. When the thermoplastic resin foamed sheet of the present invention is an automotive interior component, a sheet or non-woven fabric of thermoplastic resin or natural fiber such as woolen fabrics, hemp and jute are preferably used as a skin material. In the case of being a food container, a unilayer or multilayer gas barrier film having a layer made of an ethylene-vinyl alcohol copolymer, CPP film, etc. are widely used.

In the production of the thermoplastic resin foamed sheet of the present invention by vacuum forming, it is possible to produce a multilayer product in which a skin material has been laminated on one or both sides of the foamed sheet of the present invention by placing a skin material on the molding surface of one mold or the molding surface of each mold before supplying a softened foamed sheet between the molds. The skin material to be applied to this method is not particularly restricted with respect to its material and thickness if a foamed sheet can be shaped into the shape of a molding surface by vacuum suction through the skin material. For example, skin materials provided above as examples may be used.

The thermoplastic resin foamed sheet of the present invention is available as packaging materials such as food containers, automotive interior components, building or construction materials and household electric appliances. The automotive interior components include door trims, ceiling materials, trunk side panels, etc. The foamed sheet of the present invention is particularly suitably used as automotive interior components such as door trims because of its superior cushioning property.

It is possible to use the thermoplastic resin foamed sheet of the present invention as a sound-absorptive automotive interior material or building or construction material by forming apertures in one side of the foamed sheet to impart sound absorbability to the foamed sheet and arranging the foamed sheet such that the side thereof provided with the apertures faces the space through which sound moves to the foamed sheet. For example, when apertures having a diameter of from 0.1 mm to 5 mm are formed at intervals of from 5 mm to 50 mm in one side of the thermoplastic resin foamed sheet, the foamed sheet can absorb sound in a resonant frequency range of approximately from 100 to 5000 Hz. The resonant frequency of the sound to be absorbed can be controlled through adjustment of the size and intervals of the apertures. A thermoplastic resin foamed sheet of the present invention having been provided with apertures having a diameter of from 1 mm to 1.5 mm at intervals of 30 mm has a sound absorption characteristic which is maximum in a range approximately from 1000 to 2000 Hz. Therefore, when this foamed sheet is used as an automotive interior material, it absorbs voice and noise in a car to produce quietness. When a thermoplastic resin foamed sheet of the present invention is used as a sound absorber, it is desirable, from the viewpoint of enhancement of sound absorptivity, that the thickness be as large as possible and the closed cell percentage be as low as possible. In addition, for absorbing sound over a wide range of resonant frequencies, it is desirable that there be a variation in shape of-spaces separated by pillar-shaped resin portions located in the central portion of the foamed sheet.

When the thermoplastic resin foamed sheet of the present invention is used for applications mentioned above, a plate-like thermoplastic resin foamed sheet produced by vacuum forming may be further subjected to secondary processing into a desired shape or alternatively may be shaped into a desired form during the vacuum forming.

### EXAMPLES

The present invention is explained with reference to Examples below. The invention, however, is not limited to the Examples.

### Example 1

A two-kind three-layer initial thermoplastic resin foamed sheet in which a non-foam layer was laminated on each side of a foamed layer was produced by a method described below.

(Material for Forming a Foamed Layer)

0.1 Part by weight of calcium stearate, 0.05 part by weight of phenol-type antioxidant (commercial name: Irganox 1010, manufactured by Ciba Specialty Chemicals, Inc.) and 0.2 part by weight of phenol-type antioxidant (commercial name: Sumilizer BHT, manufactured by Sumitomo Chemical Co., Ltd.) were added to and mixed with 100 parts by weight of a propylene-based polymer powder which was prepared by the method described in Japanese Patent Application Publication No. 11-228629 and which had physical properties shown below. The mixture was melt-kneaded at 230° C. Thus, propylene-based polymer pellets (i) were produced. The melt flow rate (MFR), measured at 230° C. under a load of 2.16 kgf in accordance with JIS K6758, of the propylene-based polymer pellets (i) was 12 g/10 min. The propylene-based polymer pellets (i) were used as a material for forming a foamed layer.

Physical Properties of the Propylene-Based Polymer:

Component (A) (the component having a higher molecular weight of the two components contained in the propylene-based polymer obtained by the method disclosed in Japanese Patent Application Publication No. 11-228629):

intrinsic viscosity [η]A=8 dl/g;

content of ethylene-derived units (C2 in A)=0%; Component (B) (the component having a lower molecular weight of the two components contained in the propylene-based polymer obtained by the method disclosed in Japanese Patent Application Publication No. 11-228629):

intrinsic viscosity [η]B=1.2 dl/g;

content of ethylene-derived (C2 in B)=0%. Propylene-based polymer composed of components (A) and (B):

η₅=71,000 Pa·s and η_{0.1}=2,400 Pa·s, measured using a uniaxial elongation viscosity analyzer manufactured by Rheometrics Co. at a temperature of 180° C. and an elongation strain rate of 0.1 sec⁻¹.

(Material for Forming Non-Foamed Layer)

Polypropylene (ii) (homopolypropylene FS2011DG2 manufactured by Sumitomo Chemical Co., Ltd., MFR: 2.5 g/10 min (at 230° C., 2.16 kgf load)), polypropylene (iii) (long-chain-branching homopolypropylene named PF814 manufactured by Basell, MFR: 3 g/10 min (at 230° C., 2.16 kgf load)), polypropylene (iv) (propylene-ethylene random copolymer W151 manufactured by Sumitomo Chemical Co., Ltd., ethylene-derived structural unit content: 4.5% by weight, MFR: 8 g/10 min (at 230° C., 2.16 kgf load)) talc masterbatch (v) (block polypropylene-based talc masterbatch MF110 manufactured by Sumitomo Chemical Co., Ltd., talc content: 70 wt %), and titanium masterbatch (vi) (titanium masterbatch PPM2924 manufactured by Tokyo Ink Co., Ltd., titanium content: 60 wt %, MFR of random polypropylene base: 30 g/10 min (at 230° C., 2.16 kgf load)) were dry-blended in weight proportions of (ii)/(iii)/(iv)/(v)/(vi)=12/30/15/43/5 to yield a material for forming a non-foamed layer.

(Production of an Initial Thermoplastic Resin Foamed Sheet)

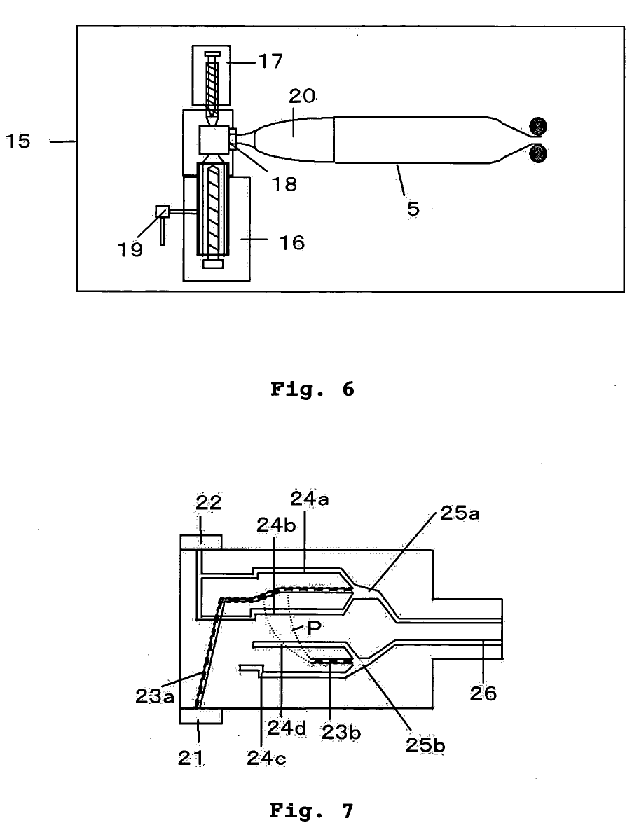

Using the materials for forming a foamed layer and a non-foamed layer described above, extrusion forming was carried out by means of an apparatus (15), shown in FIGS. 6 and 7, in which a 50 mmφ twin screw extruder (16) for extruding a foamed layer and a 32 mmφ single screw extruder (17) for extruding a non-foamed layer were connected to a 90 mmφ circular die (18). An initial thermoplastic resin foamed sheet was produced in the following manner.

A material prepared by blending 0.1 part by weight of a nucleating agent (MB1023 manufactured by Sankyo Chemical Co., Ltd.) to 100 parts by weight of the material for forming a foamed layer was supplied to the 50 mmφ twin screw extruder (16) through a hopper and kneaded in a cylinder heated to 180° C.

When the material for forming a foamed layer and the nucleating agent were melt-kneaded to be fully mixed and the nucleating agent was thermally decomposed to foam in the 50 mmφ twin screw extruder (16), 1.3 parts by weight of carbon dioxide gas as a physical foaming agent was poured from a pump (19) connected to a liquefied carbon dioxide cylinder. After the pouring of carbon dioxide gas, the mixture was further kneaded so that the resinous material was impregnated with carbon dioxide gas. Then, the resulting mixture was fed to the circular die (18). The material for forming a non-foamed layer was melt-kneaded in the 32 mmφ single screw extruder (17) and then fed to the circular die (18).

The material for forming a foamed layer was introduced into the circular die (18) through a head (21) of the 50 mmφ twin screw extruder and was conveyed toward the outlet of the die through a passageway (23a). On the midway in the passageway (23a), the material was divided through a path P and conveyed also into a passageway (23b).

The material for forming anon-foamed layer was introduced into the die through a head (8) of the 32 mmφ single screw extruder (17) and then divided into passageways (24a) and (24b). After the division, the material was transmitted toward the outlet of the die while being supplied so as to be laminated on both sides of the passageway (23a). At a point (25a), the lamination was achieved. The material for a forming non-foamed layer, which was supplied into the passageways (24a) and (24b), was divided and transmitted into passageways (25c) and (25d) through branching paths (not shown) similar to the path P. Then the material was transmitted toward the outlet of the die while being supplied so as to be laminated on both sides of the passageway (23b). At a point (25b), the lamination was achieved.

The molten resin fabricated into a tubular two-kind three-layer structure at (25a) and (25b) was extruded through the outlet (26) of the circular die (18). The release of the tubular resin to atmospheric pressure allowed the carbon dioxide gas contained in the material for forming a foamed layer to expand to form cells. Thus, a foamed layer was formed.

The two-kind three-layer foamed sheet extruded through the die was stretched and cooled while being drawn over a mandrel (6) having a maximum diameter of 700 mm to form a tube. The resulting tubular foamed sheet was cut along the longitudinal direction at two places to form two flat sheets 1080 mm wide. Each sheet was taken up on a take-up roll. Thus, an initial thermoplastic resin foamed sheet with an expansion ratio of 5 and a thickness of 1.5 mm was produced.

The initial thermoplastic resin foamed sheet obtained by the method described above was subjected to vacuum molding using a vacuum molding machine (VAIM0301 manufactured by Satoh Machinery Works, Co., Ltd.) as shown in FIG. 3. Both molds 16, 17 were female molds made of epoxy resin. Each mold had a molding surface composed of a square bottom surface sized 300 mm×300 mm and four side surfaces sized 300 mm×0.5 mm. Each mold had a parting face 15 mm wide along with the outer edge of the molding surface. Each mold had, at the four corners and on the four sides of the bottom surface of the molding surface, twelve, in total, vacuum sucking holes with a diameter of 1 mm at 10 cm intervals. The temperatures of the molds were adjusted to 60° C. during the molding.

The foamed sheet (13) was fixed in a clamp frame (14) and then was heated with an infrared heater (15) so that the surface of the sheet reached 160° C. Thus, the sheet was softened. The sheet softened had a thickness of 1.5 mm.

The sheet softened was supplied between the molds (16) and (17) while being fixed in the clamp frame.

The molds (16) and (17) were closed by being caused to approach to each other until the clearance between the parting faces of the molds became 1 mm. Concurrently with the completion of the mold closure, vacuum sucking at a degree of vacuum of −0.09 MPa through the molds was started.

0.5 second after the start of the vacuum sucking, each mold was opened at a rate of 20 mm/min. Then, the molds were stopped for five seconds at positions where the cavity height, that is to say, the distance between the bottom surfaces of the opposing molding surfaces was 3 mm.

Subsequently, the vacuum sucking was stopped and the molds were opened. Finally, the molded article produced was removed. Results of evaluations of the molded article obtained are shown in Table 1.

### Comparative Example 1

Vacuum forming was carried out in the manner described below using an initial thermoplastic resin foamed sheet the same as that used in Example 1 and molds the same as those used in Example 1 except that the molds had molding surfaces including side faces with dimensions 300 mm×0.5 mm.

The temperatures of the molds were adjusted to 60° C. during the molding. The foamed sheet was fixed in a clamp frame and then was heated with an infrared heater so that the surface of the sheet reached 160° C. Thus, the sheet was softened. The sheet softened had a thickness of 1.5 mm.

The sheet softened was supplied between the molds while being fixed in the clamp frame.

The molds were closed by being caused to approach to each other until the clearance between the parting faces of the molds became 1 mm. Concurrently with the completion of the mold closure, vacuum sucking at a degree of vacuum of −0.09 MPa through the molds was started and then the molds were held to stand for 10 seconds.

Subsequently, the vacuum sucking was stopped and the molds were opened. Finally, the molded article produced was removed. Results of evaluations of the molded article obtained are shown in Table 1.

(Measurement of Expansion Ratio)

A product sampled in a size 20 mm×20 mm was measured for the specific gravity by means of an immersion-type densimeter (Automatic Densimeter, D-H100, manufactured by Toyo Seiki Seisaku-Sho Co., Ltd.) The expansion ratio was calculated on the basis of the densities of the materials forming the product.

(Closed Cell Percentage)

In accordance with JIS K7112, the closed cell percentage F_{c} was calculated from formula (1) provided below using a sample density ρ₁ measured by use of an air picnometer (Accupyc 1330 density analyzer, manufactured by Shimadzu Corp.), a sample density ρ₂ measured by the immersion method, and a density ρ₀ of the material constituting the foamed sheet.

$${F}_{C} = \frac{( \frac{{ρ}_{0}}{{ρ}_{1}} - 1 )}{( \frac{{ρ}_{0}}{{ρ}_{2}} - 1 )} \times 100 \qquad ( 1 )$$

(Number Density of Pillar-Shaped Resin Portions Intersecting the Thickness Centerline of a Foamed Sheet)

A thermoplastic resin foamed sheet was cut across its thickness along its MD direction (the extrusion direction in the production of the foamed sheet) and a cross sectional photograph was taken such that the length of 5 mm or more and the entire thickness of the foamed sheet could be observed and also the cross sectional structure could be observed. On this cross sectional photograph, a thickness centerline of the foamed sheet, which was a line connecting centers in the thickness of the foamed sheet, was drawn. The number of all pillar-shaped resin portions intersecting the thickness centerline of the foamed-sheet observed in the cross sectional photograph was counted. Based on the result, the number of pillar-shaped resin portions per unit length of the thickness centerline of the foamed sheet was calculated. This measurement was carried out at five positions 5 cm or more away from each other. On the other hand, the thermoplastic resin foamed sheet the same as that used above was cut across its thickness along its TD direction (the width direction of the extrusion perpendicular to the MD direction of the foamed sheet) and the measurement the same as that described above was carried at five positions 5 cm or more away from each other. The average value of the so-obtained ten data of the number of pillar-shaped resin portions per unit length of the thickness centerline of the foamed sheet was defined as the number density of the pillar-shaped resin portions of the thermoplastic resin foamed sheet.

(Average Thickness of Pillar-Shaped Resin Portions Intersecting the Thickness Centerline)

In a cross sectional photograph of the foamed sheet taken in the same manner as that for taking a photograph for the determination of the number density of pillar-shaped resin portions, the thickness of all pillar-shaped resin portions intersecting the thickness centerline of the foamed sheet was measured. The measurement is conducted at five cross sections along the MD direction and five cross sections along the TD direction. All the measurements of the thickness of pillar-shaped resin portions were averaged. Thus, the average thickness of the pillar-shaped resin portions of the thermoplastic resin foamed sheet was determined.

(Average of Maximum Lengths in the Thickness Direction of Cells Found in Cross Sections in the Thickness Direction)

One cross sectional photograph taken along the MD of a foamed sheet and one cross sectional photograph taken along the TD of the foamed sheet were selected from the cross sectional photographs used for the determination of the number density of pillar-shaped resin portions. First, for all cells found in the cross sectional photograph of the foamed sheet taken in the thickness direction along the MD, each cell having a ratio of its maximum inner length in the MD to that in the thickness direction of 1 or more, maximum inner lengths in the thickness direction were recorded. On the other hand, for all cells found in the cross sectional photograph of the foamed sheet taken in the thickness direction along the TD, each cell having a ratio of its maximum inner length in the TD to that in the thickness direction of 1 or more, maximum inner lengths in the thickness direction were recorded. The so-recorded maximum inner lengths of cells in the thickness direction were averaged.

(Flexural Rigidity)

A sample 50 mm wide (in TD) and 150 mm long (in MD) was taken from a foamed sheet. The sample was set on a support table of an Autograph (Model AGS-500D, manufactured by Shimadzu Corp.), whose span was adjusted to 100 mm, so that the centers of the sample and the support table were matched. A rod-like jig having a head with a radius of curvature of 5 mm was applied to the center of the sample. While the sample was made deflect at a rate of 10 mm/min, a correlation curve between displacement (cm) and load (N) was produced. The initial slope (N/cm) was defined as the flexural rigidity of the sheet.

(Cushioning Property)

The measurement was carried out in accordance with JIS K-6767. Square samples with sides of 50 mm were taken off from a sheet to be measured. Several pieces of the samples were stacked on a flat stage of an Autograph (Model AGS-500D, manufactured by Shimadzu Corp.) so that the overall thickness of the samples became about 25 mm. The samples were compressed with a compression jig at a rate of 10 mm/min. The load (N) applied at a time 20 seconds after the samples were shrunk by 25% with respect to the thickness before the compression was measured. The load was divided by the surface area of the sample (2500 mm²) and the quotient was used as a measure of cushioning property.

TABLE 1

| | | | Comparative |
|---|---|---|---|
| | | Example 1 | Example 1 |
| Initial sheet thickness | mm | 1.5 | 1.5 |
| Initial sheet expansion | | 5 | 5 |
| ratio | | | |
| Sheet thickness after | mm | 3 | 2 |
| molding | | | |
| Sheet expansion ratio | | 10 | 7 |
| after molding | | | |
| Closed cell percentage | % | 5 | 10 |
| Number density of pillar- | pillars/mm- | 6 | 3 |
| shaped resin portions | centerline | | |
| intersecting the thickness | | | |
| centerline of a foamed | | | |
| sheet after molding | | | |
| Average thickness of | μm | 140 | 800 |
| pillar-shaped resin | | | |
| portions intersecting the | | | |
| thickness centerline of a | | | |
| foamed sheet after molding | | | |
| Average of maximum inner | μm | 220 | 180 |
| lengths of cells in the | | | |
| thickness direction of a | | | |
| foamed sheet after molding | | | |
| Flexural modulus of a | N/cm | 18 | 11 |
| foamed sheet after molding | | | |
| Cushioning property of a | N/cm² | 0.4 | 4 |
| foamed sheet after molding | | | |

(Sound Absorption Characteristics)

The sound absorption characteristic was measured in accordance with JIS-A-1405.

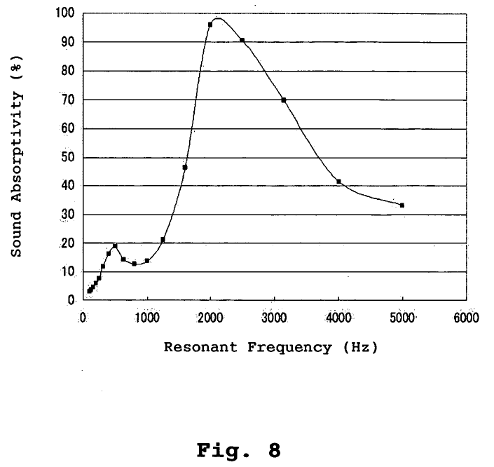

A sample 92 mm4 in diameter was taken from the sheet produced in Example 1. The sample was provided with four apertures 1 mm in diameter at intervals of 30 mm and five apertures 1.5 mmφ in diameter at intervals of 30 mm. The sample was placed in an acoustic tube (TYPE 3G-3E, manufactured by Japan Electronic Instrument Co., Ltd.). Then, signals produced by a test signal generator (TYPE 01022, manufactured by Japan Electronic Instrument Co., Ltd.) was applied to the sample and the signals reflected were detected by a precision sound level meter (LR-06, manufactured by RION Co., Ltd.). Thus, the sound absorptivity at resonant frequencies within the range of from 100 to 2000 Hz was determined. From the same sheet taken was a sample 40 mmφ in diameter, which was provided with two apertures 1 mmφ in diameter at intervals of 30 mm and two apertures 1.5 mmφ in diameter at 30 mm intervals. Then, the sound absorptivity at resonant frequencies within the range of from 1600 to 5000 Hz was determined in the same manner as described above. The sound absorptivities are shown in FIG. 8.

1. A thermoplastic resin foamed sheet wherein pillar-shaped resin portions observed in a cross section in the thickness direction of the sheet satisfy requirements (1) and (2) defined below:
(1) the number density of pillar-shaped resin portions intersecting the thickness centerline of the foamed sheet is from 1 to 20 pillars/mm-centerline;
(2) the average thickness of pillar-shaped resin portions intersecting the thickness centerline of the foamed sheet is from 10 to 500 μm.

2. The thermoplastic resin foamed sheet according to claim 1, wherein the average of maximum inner lengths in the foamed sheet's thickness direction of all cells found in a cross section of the foamed sheet taken in the thickness direction along the MD, each cell having a ratio of its maximum inner length in the MD to that in the thickness direction of 1 or more, and all cells found in a cross section of the foamed sheet taken in the thickness direction along the TD, each cell having a ratio of its maximum inner length in the TD to that in the thickness direction of 1 or more, is within the range of from 10 to 500 μm.

3. The thermoplastic resin foamed sheet according to claim 1, wherein the sheet has an expansion ratio of from 5 to 40, a thickness of from 2 to 50 mm, and a closed cell percentage of from 0 to 30%.

4. An automotive interior component comprising the thermoplastic resin foamed sheet according to claim 1.

5. A sound absorber comprising the thermoplastic resin foamed sheet according to claim 1.
